(19) United States
(12) Patent Application Publication
(10) Pub. No.: US 2009/0159693 A1
(43) Pub. Date: Jun. 25, 2009

(54) Method of Incorporating a Fast, Readable Data Chip into Metallic Surfaces for Electronic Identification

(76) Inventor: Richard Steffensen, Stavanger (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/064,323

(22) PCT Filed: Aug. 21, 2006
(86) PCT No.: PCT/NO2006/000301

§ 371 Date: Jun. 10, 2008

(30) Foreign Application Priority Data
Aug. 25, 2005 (NO) 20053906

(51) Int. Cl. G06K 19/00; B23P 11/00

(52) U.S. Cl. 235/492; 29/428

(57) ABSTRACT

The invention regards a method of incorporating a readable data chip into metallic surfaces for electronic identification. A shock-absorbed data chip is placed in a transverse hole in a cylindrical plug with tight threads, the plug of which is screwed into a ring-shaped plug holder, the internal periphery of which is provided with tight threads. The lower and external periphery is straight and provided with threads, whereas the upper and external periphery is machined into an outwardly directed cone in the region of 30°, and with no threads.

Upon mounting, the plug holder is initially screwed into a hole in the pipe wall until the periphery of the cone engages a corresponding cone in the pipe wall. Then the plug is screwed down into the plug holder by means of two mounting holes, the placement of which indicates that the data chip is positioned in the longitudinal direction of the pipe.

By removing conductive materials from the regions surrounding the data chip, allows data to be read faster by means of electromagnetic waves generated by an external transmitter/receiver positioned where the data chip is provided with a fixed passing point.

Magnetic leakage at the transition between the cone and the threaded portion of the plug holder is transmitted in the surrounding material, and the leakage is directed towards the data chip, too.

The invention regards a method of incorporating a fast, readable data chip into metallic surfaces for electronic identification, as stated in the preamble of the accompanying claim 1.

The need to label units for identification arises when, for various reasons, each unit must be identifiable. Colour coding, bar coding and numeric coding depend on a clean surface for optical reading and have little resistance against rough treatment, such as impacts and rubbing, in environments involving oil, saline water etc. Electronic chips depend on batteries or a power supply. These chips, which are affected by electromagnetic noise, represent a certain explosion hazard and have relatively little resistance against the above-mentioned rough treatment.

Oftentimes the labelling of metallic units already takes place during the production process, such as in the production of railway rails, which during the last stage of rolling are continuously stamped with the manufacturer's name and the year, e.g. “KRUPP 1916”. Similar recesses may be formed in moulds of various types, displaying a name or logo, such as ESCO on fire hydrants, recessed into or projecting from the metal. Furthermore, engines, for example, are labelled with an affixed plate carrying the serial number and other identifying information. Likewise, numbering may be carried out by means of stamping carbide numbers into metallic materials. None of the aforementioned methods may be used to label pipe joints that are joined into drill strings in the oil industry.

Currently, the labelling of such pipe joints is carried out by means of painting/writing the number onto the joint. Colour coding for different types of steel is also used. The number on each pipe joint is tracked via data processing, continuously recording, among other things, the length of individual pipes in view of the number of times they have been cut and re-threaded.

When a new drilling operation is to be carried out, the pipe joints are joined into a continuous drill string. Electronically joining the individual numbers of the pipes used in the computer will provide the exact length of the drill string established at any time.

So far a continuous mechanized recording of the identification of individual pipe joints has not been possible. The need for this type of recording exists, and such automatic scanning would also have contributed towards improved quality assurance of the individual pipes before, during and after inspections associated with the cutting and re-threading thereof.

Attempts have been made to recess electronic identification chips into the pipe material. This, however, has proven impossible to implement in practice, primarily because electronics are not permitted offshore due to the explosion hazard, and because such chips would not be able to withstand the shock-like loads imparted on the pipes during drilling and during the handling thereof.

The following publications describe the state of the art:
U.S. Pat. No. 4,533,823 Vittorio describes a system for using bar codes to label machine parts.
U.S. Pat. No. 4,202,490 Gunkel & Lybecker describes labelling of drill pipes with binary numerals made by means of an apparatus consisting of non-metallic material.
U.S. Pat. No. 5,606,165 Chiou & Augeri describes the use of an apparatus consisting of transparent and opaque cells arranged in a code or a pattern, and placed before a radioactive source in order to show the radioactive radiation.

None of the aforementioned patents describe any form of incorporation of data chips into a metallic surface.

The present application concerns a method of incorporating a fast, readable data chip into metallic surfaces for electronic identification, and the method is characterized by the characteristics set forth in the claims.

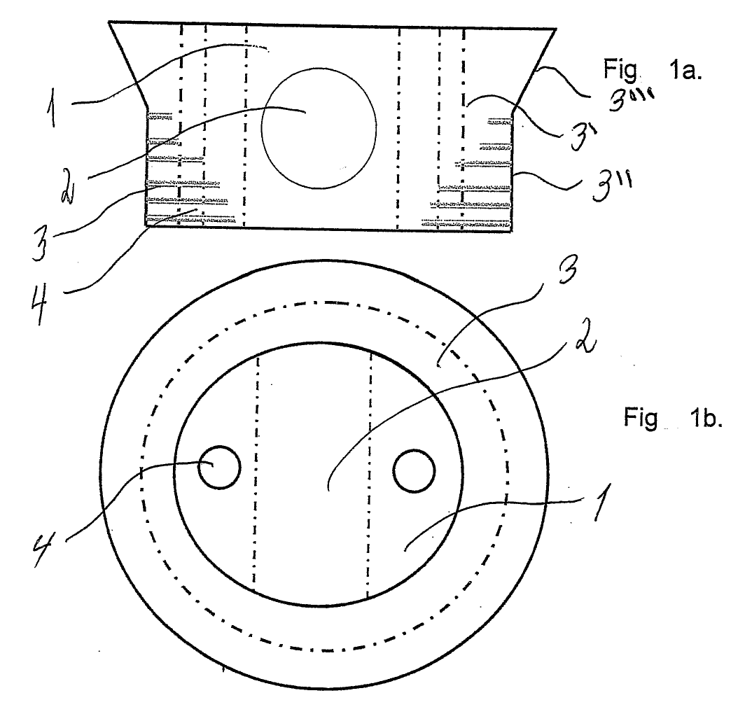

FIGS. 1-3 show the manner in which the incorporation of a data chip is done, and the various elements involved.

FIG. 1A is a sectional side view showing the manner in which the incorporation of a shock-absorbed data chip is carried out, the chip of which is placed in a transverse hole 2 in a cylindrical plug 1 provided with tight threads 1′, the plug of which is screwed into a ring-shaped plug holder 3, the internal periphery of which is provided with threads 3′, and the lower and external periphery of which is straight and provided with threads 3″, whereas the upper and external periphery of which is provided with an outwardly directed cone 3′″ and having no threads. The plug 1 is screwed down by means of two mounting holes 4, the placement of which indicates that the data chip is positioned in the longitudinal direction of the pipe;

FIG. 1B is a top view showing the manner in which the data chip will be positioned in the hole 2 in the plug 1 under the surface, in which the plug 1 is screwed down into the plug holder 3, the plug holder of which is initially screwed into a machined hole in the pipe wall until the periphery of the cone 3′″ engages a corresponding cone in the pipe wall;

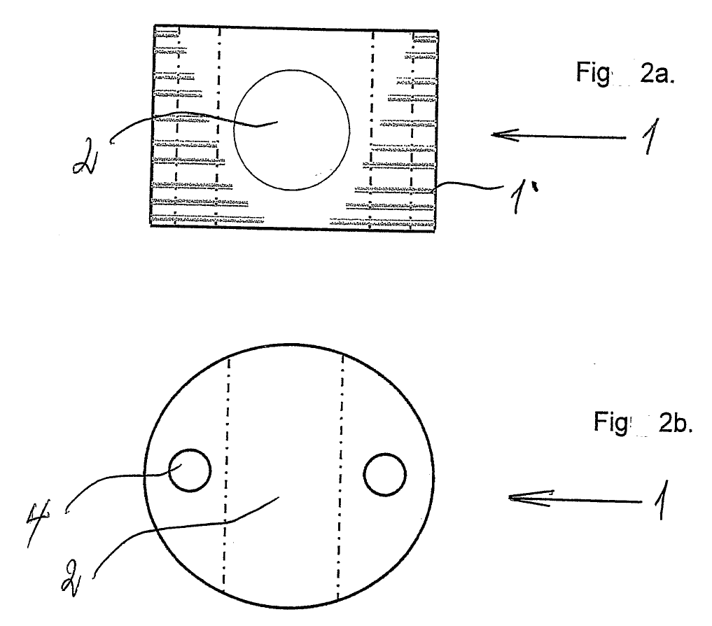

FIG. 2A is a sectioned side view of the cylindrical plug 1 provided with threads 1′ and the transverse hole 2 for the data chip;

FIG. 2B is a corresponding top view thereof;

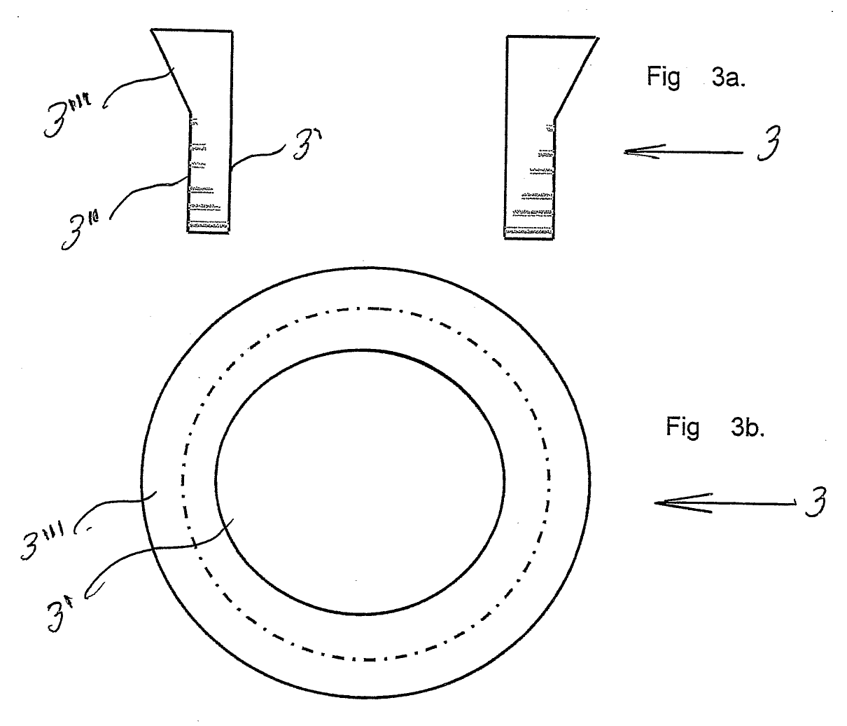

FIG. 3A is a sectioned side view of the ring-shaped plug holder 3 with its internal periphery provided with threads 3′, with its lower and external periphery provided with threads 3″, and with its upper and external periphery provided with an outwardly directed cone 3′″; and

FIG. 3B is a corresponding top view thereof.

The plug 1 and the plug holder 3 are machined from the metal PEEK, which is characterized by having a strength and impact resistance resembling that of steel/metal.

The data chip is not connected to a battery. By virtue of its placement in the longitudinal direction of the pipe, however, it may be read by means of electromagnetic waves generated by an external transmitter/receiver positioned in vicinity of the drill floor, i.e. in the area where the data chip is provided with a fixed passing point, such as on a drill floor.

A cone angle in the region of 30° is vital in order to achieve a fast and reliable recording. The cone is not significantly exposed to external influences, such as impacts and shocks, and it does not weaken the drill pipe. The cone causes the data chip to become more exposed to the electromagnetic waves owing to the fact that a larger amount of conductive material has been removed from the regions surrounding the data chip. Moreover, it is a known fact that magnetic leakage points form at right-angled corners/buckles in materials. In this connection, this causes the magnetic leakage occurring at the transition between the plug holder cone and the threads, and which is transmitted in the surrounding metal, to be utilized at its maximum, insofar as this magnetic leakage is directed towards the data chip, too.

1. A method of incorporating a readable data chip into metallic surfaces for electronic identification, characterized in that a data chip is placed in a transverse hole in a cylindrical plug provided with external threads,
wherein the cylindrical plug is screwed into a ring-shaped plug holders having an internal surface provided with threads,
wherein an external and innermost section of the plug holder, which is cylindrical, is provided with threads, whereas an external and outermost section of the plug holder is provided with an outwardly directed cone, and
wherein the plug holder, upon mounting, is screwed into a machined hole in a metallic material until the cone engages a corresponding cone in the metallic material, the plug being screwed into the plug holder by means of two mounting holes.

2. The method according to claim 1, characterized in that, by removing a larger amount of conductive material from the regions surrounding the data chip, which is positioned in the chip's reading direction in the metallic material, fast data are read from the data chip by means of electromagnetic waves generated by an external transmitter/receiver positioned where the data chip is provided with a fixed passing point.

3. The method according to claim 1, characterized in that the maximum use is made of magnetic leakage at the transition between the cone and threaded portion of the plug holder, by also directing this magnetic leakage towards the data chip.

4. A device for incorporating a readable data chip into metallic surfaces for electronic identification, characterized in that a generally cylindrical plug provided with threads and a transverse openings relative to the longitudinal axis thereof, fits into a corresponding and ring-shaped plug holder provided with internal threads, in which an external and innermost section of the plug holder is provided with a substantially cylindrical portion provided with threads, whereas an external and outermost section of the plug holder is provided with an outwardly directed cone.

5. The method according to claim 1, characterized in that the plug is provided with mounting holes.

6. The method according to claim 1, characterized in that the orientation of the mounting holes indicates the orientation of the data chip relative to the orientation of an external transmitter/receiver.
